(19) United States
(12) Patent Application Publication
(10) Pub. No.: US 2019/0056752 A1
(43) Pub. Date: Feb. 21, 2019

(54) SYSTEMS AND METHODS FOR CONTROLLING UNMANNED TRANSPORT VEHICLES VIA INTERMEDIATE CONTROL VEHICLES

(71) Applicant: Walmart Apollo, LLC, Bentonville, AR (US)

(72) Inventors: David C. Winkle, Bella Vista, AR (US); Donald R. High, Noel, MO (US); John J. O'Brien, Farmington, AR (US); Todd D. Mattingly, Bentonville, AR (US)

(21) Appl. No.: 16/052,954

(22) Filed: Aug. 2, 2018

Related U.S. Application Data
(60) Provisional application No. 62/546,721, filed on Aug. 17, 2017.

(51) Int. Cl. G05D 1/02; G05D 1/00; G06Q 10/08; H04W 4/40

(52) U.S. Cl. CPC G05D 1/0295; G05D 1/0088; G05D 2201/0216; H04W 4/40; G06Q 10/083

(57) ABSTRACT

In some embodiments, methods and systems are provided that provide for controlling aerial and/or ground transport vehicles that are located beyond a communication range of a central control station via one or more aerial and/or ground intermediate control vehicles.

### CROSS-REFERENCE TO RELATED APPLICATION

This application claims the benefit of U.S. Provisional Application No. 62/546,721, filed Aug. 17, 2017, which is incorporated herein by reference in its entirety.

### TECHNICAL FIELD

This disclosure relates generally to controlling unmanned transport vehicles and, in particular, to controlling unmanned transport vehicles via an intermediate control vehicle.

### BACKGROUND

Product delivery using unmanned aerial vehicles (UAVs) and/or unmanned ground vehicles (AGVs) is becoming a popular idea. The UAVs/AGVs would be expected to deliver products over wide territories and would be monitored and/or controlled by one or more computing devices at a central control station. Generally, as a UAV/AGV travels further away from the central control station, the wireless communication signals between the central control station and the UAV/AGV would be expected to degrade. This may, in some instances, lead to situations where the central control station would be unable to monitor and/or control the UAV/AGV when the UAV/AGV is near and/or beyond the limits of the communication range of the central control station. Such communication limitations between UAVs/AGVs and their central control stations may require the installation of more central control stations to cover more geographic area, thereby significantly increasing the cost of such product transportation systems.

### BRIEF DESCRIPTION OF THE DRAWINGS

Disclosed herein are embodiments of systems, apparatuses, and methods for controlling unmanned transport vehicles. This description includes drawings, wherein:

FIG. 1 is a diagram of a system for controlling unmanned transport vehicles in accordance with some embodiments;

FIG. 2 is a functional diagram of an exemplary computing device usable with the system of FIG. 1 in accordance with some embodiments;

FIG. 3 comprises a block diagram of an unmanned transport vehicle (UTV) as configured in accordance with some embodiments; and

FIG. 4 comprises a block diagram of an intermediate unmanned control vehicle (IUCV) as configured in accordance with some embodiments; and

FIG. 5 is a flow chart diagram of a process controlling unmanned transport vehicles in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, the systems, devices, and methods described herein relate to controlling unmanned transport vehicles via a central computing device and an intermediate control vehicle.

In some embodiments, a system for controlling a plurality of unmanned transport vehicles includes a plurality of unmanned transport vehicles configured to transport commercial retail products and goods not for sale from a deployment station to a delivery destination along a delivery route, each of the unmanned transport vehicles including at least one sensor configured to detect and transmit over a network status data associated with the unmanned transport vehicles during movement of the unmanned transport vehicles along the delivery route; a central computing device including a processor-based control unit and configured to communicate with at least one of the unmanned transport vehicles located within a communication range of the central computing device; and an intermediate unmanned control vehicle located remote to the central computing device and configured to communicate with the central computing device and with at least one of the unmanned transport vehicles located outside of the communication range of the central computing device. The intermediate unmanned control vehicle is configured to receive the status data that is transmitted by the unmanned transport vehicles and delivery route data associated with the unmanned transport vehicles that is transmitted by the central computing device. The intermediate unmanned control vehicle includes a processor-based control circuit configured to analyze the status data received from the unmanned transport vehicles and the delivery route data received from the central computing device and to alter the delivery route of one or more of the unmanned transport vehicles based on at least one of the status data and the delivery route data. The wherein the intermediate unmanned control vehicle facilitates communication between the central computing device and the at least one of the unmanned transport vehicles located outside of the communication range of the central computing device.

In some embodiments, a method for controlling a plurality of unmanned transport vehicles includes: providing a plurality of unmanned transport vehicles configured to transport commercial retail products and goods not for sale from a deployment station to a delivery destination along a delivery route, each of the unmanned transport vehicles including at least one sensor configured to detect and transmit over a network status data associated with the unmanned transport vehicles during movement of the unmanned transport vehicles along the delivery route; providing a central computing device including a processor-based control unit and configured to communicate with at least one of the unmanned transport vehicles located within a communication range of the central computing device; providing an intermediate unmanned control vehicle located remote to the central computing device and configured to communicate with the central computing device and with at least one of the unmanned transport vehicles located outside of the communication range of the central computing device; receiving, by the intermediate unmanned control vehicle, the status data that is transmitted by the unmanned transport vehicles and delivery route data associated with the unmanned transport vehicles that is transmitted by the central computing device; analyzing by a processor-based control circuit of the intermediate unmanned control vehicle, the status data received from the unmanned transport vehicles and the delivery route data received from the central computing device; altering, via the control circuit of the intermediate unmanned control vehicle, the delivery route of one or more of the unmanned transport vehicles based on at least one of the status data and the delivery route data; and facilitating, via the intermediate unmanned control vehicle, communication between the central computing device and the at least one of the unmanned transport vehicles located outside of the communication range of the central computing device.

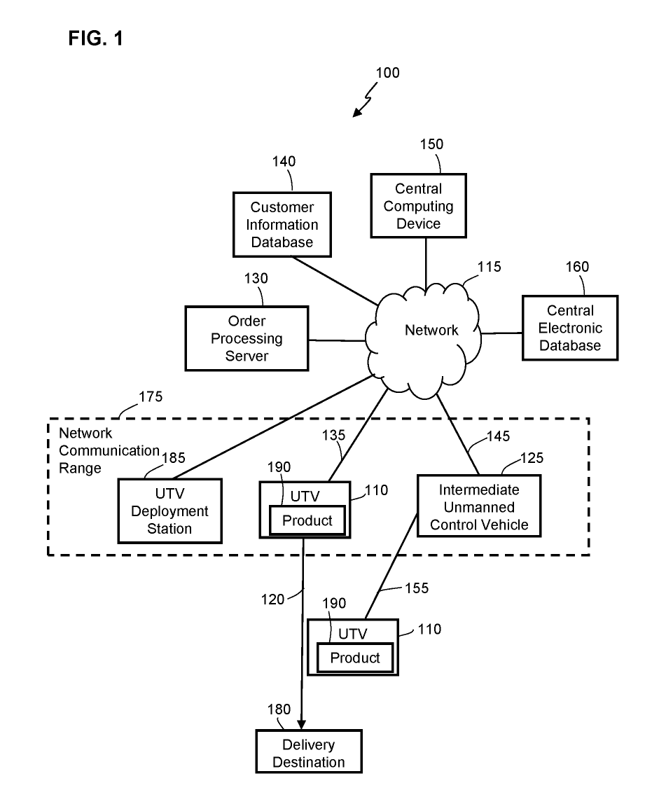

FIG. 1 shows an embodiment of a system 100 for controlling UTVs 110. It will be understood that the details of this example are intended to serve in an illustrative capacity and are not necessarily intended to suggest any limitations in regards to the present teachings. In some aspects, the exemplary UTV 110 of FIG. 1 is configured to transport one or more products 190 from one or more UTV deployment stations 185 to one or more delivery destinations 180 via one or more delivery routes 120. In other aspects, the UTV 110 is configured to travel along the delivery route 120 from a UTV deployment station 185 to a product pick up location. In yet other aspects, the UTV 110 is configured to travel along the delivery route 120 from a delivery destination 180 back to the UTV deployment station 185.

A customer may be an individual or business entity. A delivery destination 180 may be a home, work place, or another location designated by the customer when placing the order or scheduling a product return pick-up. Products 190 that may be delivered via the UTVs 110 of the system 100 may include but are not limited to general-purpose consumer goods (retail products and goods not for sale) and consumable products (e.g., food items, medications, or the like). A UTV deployment station 185 can be mobile (e.g., vehicle-mounted) or stationary (e.g., installed at a facility of a retailer). A retailer may be any entity operating as a brick-and-mortar physical location and/or a website accessible, for example, via an intranet, internet, or another network, by way of which products 190 may be ordered by a consumer for delivery via a UTV 110.

The exemplary system 100 depicted in FIG. 1 includes an order processing server 130 configured to process a purchase order by a customer for one or more products 190. It will be appreciated that the order processing server 130 is an optional component of the system 100, and that some embodiments of the system 100 are implemented without incorporating the order processing server 130. The order processing server 130 may be implemented as one server at one location, or as multiple interconnected servers stored at multiple locations operated by the retailer, or for the retailer. As described in more detail below, the order processing server 130 may communicate with one or more electronic devices of system 100 via a network 115. The network 115 may be a wide-area network (WAN), a local area network (LAN), a personal area network (PAN), a wireless local area network (WLAN), Wi-Fi, Zigbee, Bluetooth, or any other internet or intranet network, or combinations of such networks. Generally, communication between various electronic devices of system 100 may take place over hard-wired, cellular, Wi-Fi or Bluetooth networked components or the like. In some embodiments, one or more electronic devices of system 100 may include cloud-based features, such as cloud-based memory storage.

In the embodiment of FIG. 1, the order processing server 130 communicates with a customer information database 140. In some embodiments, the customer information database 140 may be configured to store information associated with customers of the retailer who order products 190 from the retailer. In some embodiments, the customer information database 140 may store electronic information including but not limited to: personal information of the customers, including payment method information, billing address, previous delivery addresses, phone number, product order history, pending order status, product order options, as well as product delivery options (e.g., delivery by UTV) of the customer. The customer information database 140 may be stored, for example, on non-volatile storage media (e.g., a hard drive, flash drive, or removable optical disk) internal or external to the order processing server 130, or internal or external to computing devices separate and distinct from the order processing server 130. It will be appreciated that the customer information database 140 may likewise be cloud-based.

In the embodiment of FIG. 1, the order processing server 130 is in communication with a central electronic database 160 configured to store information associated with the inventory of products 190 made available by the retailer to the customer, as well as information associated with the UTVs 110 being deployed to deliver products 190 to the delivery destinations 180 specified by the customers. In some aspects, the central electronic database 160 stores information including but not limited to: information associated with the products 190 being transported by the UTV 110; inventory (e.g., on-hand, replenishment, sold, in-transit, etc.) information associated with the products 190; information associated with the UTV 110 and the IUCV 125; UTV status input information detected by one or more sensors of the UTV 110 during movement along the delivery route 120; global positioning system (GPS) coordinates of the UTV 110 and IUCV 125; and control signals and/or instructions transmitted over the network 115 between the central computing device 150, UTV 110, and/or IUCV 125.

The central electronic database 160 may be stored, for example, on non-volatile storage media (e.g., a hard drive, flash drive, or removable optical disk) internal or external to the order processing server 130, or internal or external to computing devices separate and distinct from the order processing server 130. The central electronic database 160 may likewise be cloud-based. While the customer information database 140 and the central electronic database 160 are shown in FIG. 1 as two separate databases, it will be appreciated that the customer information database 140 and the central electronic database 160 can be incorporated into one database.

With reference to FIG. 1, the central computing device 150 may be a stationary or portable electronic device, for example, a desktop computer, a laptop computer, a tablet, a mobile phone, or any other electronic device including a processor-based control circuit (i.e., control unit). In this specification, the term “central computing device” will be understood to refer to a computing device owned by the retailer or any computing device owned and/or operated by an entity (e.g., delivery service) having an obligation to deliver products 190 for the retailer. The central computing device 150 of FIG. 1 is configured for data entry and processing and for communication with other devices of system 100 via the network 115. In some embodiments, as will be described below, the central computing device 150 is configured to access the central electronic database 160 and/or customer information database 140 via the network 115 to facilitate delivery of products 190 via UTVs 110 along delivery routes 120 to delivery destinations 180.

In the system 100 shown in FIG. 1, the central computing device 150 is in two-way communication with the UTV 110 via the network 115. As can be seen in FIG. 1, when the UTV 110 is located within the communication range 175 of the central computing device 150 via the network 115, the central computing device 150 is permitted to transmit signals (e.g., via communication channel 135) directly to the UTV 110 and to receive signals directly (e.g., via communication channel 135) from the UTV 110 over the network 115. In the exemplary embodiment depicted in FIG. 1, when the UTV is located outside of the communication range 175 of the central computing device 150 via the network 115 such that the central computing device 150 is no longer permitted to transmit signals to/receive signals directly from the UTV 110 over the network 115, the system 100 includes an intermediate unmanned control vehicle (IUCV) 125 that is located within the communication range 175, and which enables the central computing device 150 to transmit signals to the UTV 110 and receive signals from the UTV 110 over the network 115 via the IUCV 125 and the communication channels 145, 155 associated therewith. In other words, in the embodiment illustrated in FIG. 1, when the central computing device 150 communicates with a UTV 110 that is located outside of the communication range 175 of the central computing device 150 via the network 115, the central computing device 150 transmits the signal via communication channel 145 directly to the IUCV 125 (which is located within the communication range 175), and which in turn relays this signal via communication channel 155 to the UTV 110 that is located outside of the communication range 175.

In some aspects, the central computing device 150 is configured to transmit at least one signal to the UTV 110 to cause the UTV 110 to travel along a delivery route 120 (determined by the central computing device 150) while transporting products 190 from the UTV deployment station 185 to the intended delivery destination 180 (e.g., to drop off a product 190 or to pick up a product 190), or while returning from the delivery destination 180 to the UTV deployment station 185 (e.g., after dropping off or after picking up a product 190). In other aspects, after a customer places an on order for one or more products 190 and specifies a delivery destination 180 for the products 190 via the order processing server 130, prior to and/or after the commencement of a delivery attempt of the products 190 ordered by the customer via a UTV 110 to the delivery destination 180, the central computing device 150 is configured to obtain GPS coordinates associated with the delivery destination 180 selected by the customer and GPS coordinates associated with the UTV deployment station 185 of the retailer (which houses the UTV 110 that will deliver the products 190), and to determine a delivery route 120 for the UTV 110 in order to deliver the customer-ordered products 190 from the UTV deployment station 185 to the delivery destination 180. In some embodiments, as will be discussed below, the central computing device 150 is configured to determine that the delivery route 120 will cause the UTV 110 to travel outside of the communication range 175 of the central computing device 150 via the network 115 and, based on such a determination, to cause the UTV 110 to communicate with the IUCV 125 and vice versa when the UTV 110 is traveling along a portion of the delivery route 120 located outside of the communication range 175.

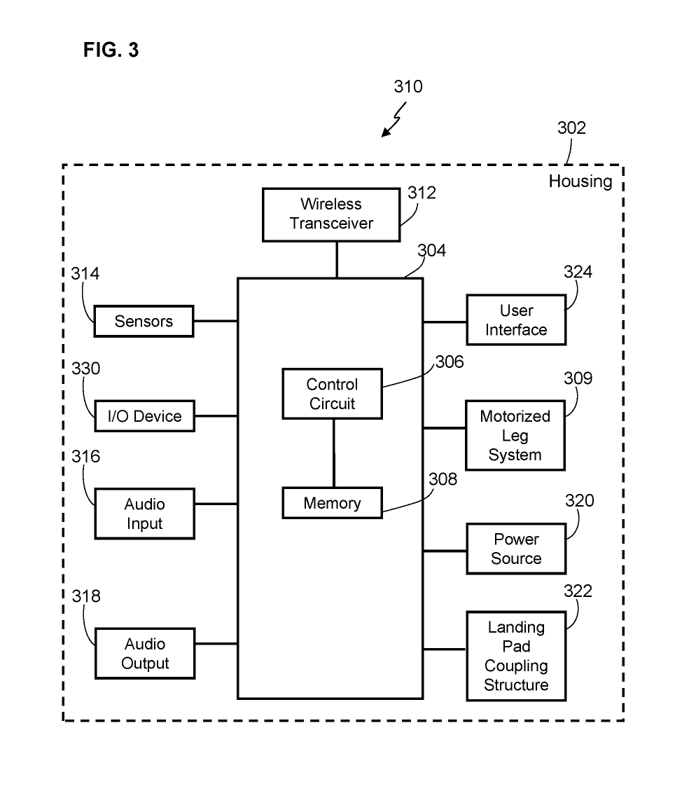

The UTV 110, which will be discussed in more detail below with reference to FIG. 3, is generally an unmanned vehicle (e.g., an unmanned aerial vehicle (UAV) or autonomous ground vehicle (AGV)) configured to autonomously traverse one or more intended environments in accordance with one or more delivery routes 120 determined by the central computing device 150, and typically without the intervention of a human or a remote computing device, while retaining the products 190 therein and delivering the products 190 to the delivery destination 180. In some instances, however, a remote operator or a remote computer (e.g., central computing device 150) may temporarily or permanently take over operation of the UTV 110 using feedback information (e.g., audio and/or video content, sensor information, etc.) communicated from the UTV 110 to the remote operator or computer via the network 115, or another similar distributed network. In other words, while the present application refers to the transport vehicle 110 as being “unmanned,” in some embodiments, the unmanned transport vehicle 110 is a human operator-controlled vehicle. While only one UTV 110 is shown in FIG. 1 for ease of illustration, it will be appreciated that in some embodiments, the central computing device 150 may communicate (directly over the network 115 or via one or more IUCVs 125) with, and/or provide delivery route instructions to more than one (e.g., 5, 10, 20, 50, 100, 1000, or more) UTVs 110 simultaneously to guide the UTVs 110 to transport products 190 to their respective delivery destinations 180.

In some embodiments, as will be discussed in more detail below, the UTV 110 is equipped with one or more sensors configured to detect and transmit (e.g., internally to the UTV 110 and/or over the network 115) at least one status input associated with the UTV 110 during movement of the UTV 110 along the delivery route 120. In addition, in some aspects, the UTV 110 includes a processor-based control circuit configured to determine, based on an analysis of the status input, that the UTV 110 is headed toward exiting (or is outside of) the communication range 175, as well as to generate and transmit a signal including electronic data (e.g., an alert) indicative of this determination over the network 115 to the central computing device 150 and/or IUCV 125.

With reference to FIG. 1, the IUCV 125 can include but is not limited to: one or more unmanned aerial vehicles, autonomous ground vehicles, manned ground vehicles, manned aerial vehicles, and combinations thereof. In other words, while the present application refers to the intermediate control vehicle 125 as being “unmanned,” in some embodiments, the intermediate control vehicle 125 is a human operator-controlled vehicle. With reference to FIG. 1, the IUCV is configured to communicate with the central computing device 150 over the network 115 via the communication channel 145 and to communicate with the UTV located outside of the communication range 175 via the communication channel 155. In other words, the communication channel 155 enables the IUCV 125 to relay signals transmitted by the central computing device 150 even to a UTV 110 located outside of the communication range 175 of the central computing device 150. It will be appreciated that the IUCV 125 may likewise relay to the UTV 110, via the communication channel 155, the signals transmitted from the central electronic database 160 and/or order processing server 130, and to relay to the central electronic database 160 and/or order processing server 130 the signals transmitted by the UTV 110.

It will be appreciated that the IUCV 125 is configured to perform functions additional to simply relaying signals between the various electronic devices of the system 100. For example, in some embodiments, the IUCV 125 is configured to perform various functions, which will be described in more detail below, and which include but are not limited to: recharging the UTV 110 via physical coupling or induction signals, receiving sensor input (e.g., GPS data, still images, videos, etc.) from the UTV 110, tracking the location of the UTV 110, rerouting the UTV 110, detecting presence of electronic devices that may disrupt the functions and/or communication ability of the UTV 110, and authenticating electronic devices that attempt to communicate with the UTV 110.

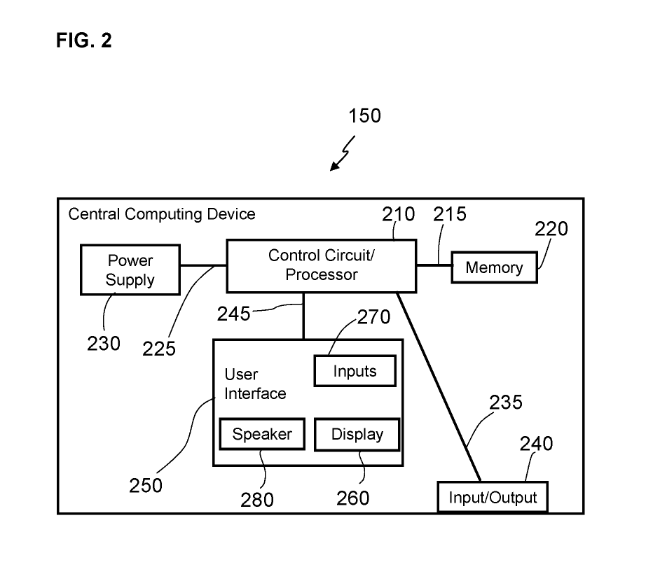

With reference to FIG. 2, an exemplary central computing device 150 configured for use with the systems and methods described herein may include a control unit or control circuit 210 including a processor (for example, a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 210 of the central computing device 150 can be configured (for example, by using corresponding programming stored in the memory 220 as will be well understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Thus, the memory and/or the control circuit may be referred to as a non-transitory medium or non-transitory computer readable medium.

The control circuit 210 of the central computing device 150 is also electrically coupled via a connection 235 to an input/output 240 that can receive signals from the UTV 110 and/or IUCV 125 and/or order processing server 130 and/or customer information database 140 and/or central electronic database 160. For example, the central computing device 150 can receive signals including but not limited to: sensor data from the UTV 110 (or IUCV 125) representing at least one status input associated with the UTV 110 during movement of the UTV 110 along the delivery route 120, data from the order processing server 130 and/or customer information database 140 and/or central electronic database 160 relating to an order for a product 190 placed by the customer, location data (e.g., GPS coordinates) associated with the UTV 110 and/or IUCV 125 and/or delivery destination 180 selected by the customer, or from any other source that can communicate with the central computing device 150 via a wired or wireless connection. The input/output 240 of the central computing device 150 can also send signals to the UTV 110 (e.g., a control signal indicating a delivery route 120 determined by the central computing device 150 for the UTV 110 in order to deliver the product 190 from the UTV deployment station 185 to the delivery destination 180). The input/output 240 of the central computing device 150 can also send signals to the order processing server 130 (e.g., notification indicating that the UTV 110 successfully delivered the product 190 to the delivery destination 180).

In the embodiment of FIG. 2, the processor-based control circuit 210 of the central computing device 150 is electrically coupled via a connection 245 to a user interface 250, which may include a visual display or display screen 260 (e.g., LED screen) and/or button input 270 that provide the user interface 250 with the ability to permit an operator of the central computing device 150 to manually control the central computing device 150 by inputting commands via touch-screen and/or button operation and/or voice commands to, for example, to transmit a control signal to the UTV 110 in order to provide the UTV 110 with the delivery route 120 from the UTV deployment station 185 to the delivery destination 180, to transmit a signal directly to the UTV 110 when the UTV 110 is located within the network communication range 175, and/or to transmit a signal to the UTV 110 via the IUCV 125 when the UTV 110 is outside of the network communication range 175. It will be appreciated that the performance of such functions by the control circuit 210 of the central computing device 150 is not dependent on a human operator, and that the control circuit 210 may be programmed to perform such functions without a human operator.

In some aspects, the display screen 260 of the central computing device 150 is configured to display various graphical interface-based menus, options, and/or alerts that may be transmitted to the central computing device 150 and displayed on the display screen 260 in connection with various aspects of the delivery of the products 190 ordered by the customers by the UTVs 110, various aspects of monitoring the UTVs 110 while they are in-route, and various aspects of communicating with the UTVs 110 via the IUCVs 125 to enable the UTVs 110 to successfully complete their missions. The inputs 270 of the central computing device 150 may be configured to permit an operator to navigate through the on-screen menus on the central computing device 150, for example, to change and/or update the delivery route 120 of the UTV 110 toward or away from the delivery destination 180 and/or to reroute a UTV 110 (e.g., to avoid an obstacle or a no-fly zone, or to recharge) from the delivery route 120. It will be appreciated that the display screen 260 may be configured as both a display screen and an input 270 (e.g., a touch-screen that permits an operator to press on the display screen 260 to enter text and/or execute commands.)

In some embodiments, after an order for one or more products 190 is placed by a customer via the order processing server 130, and prior to commencement of the delivery attempt of one or more products 190 via the UTV 110 to the delivery destination 180 designated by the customer, the control circuit 210 of the central computing device 150 is programmed to obtain the GPS coordinates of the delivery destination 180 where the product 190 is to be delivered by the UTV 110. For example, in embodiments, where the customer requested delivery of a product 190 or products 190 to a delivery destination 180 associated with a specific geographic location (e.g., home address, work address, etc.), the control circuit 210 of the central computing device 150 obtains the GPS coordinates associated with the delivery destination 180, for example, from the customer information database 140, or from another source configured to provide GPS coordinates associated with a given physical address.

In some embodiments, the control circuit 210 of the central computing device 150 is configured to analyze the GPS coordinates of both the UTV deployment station 185 and the delivery destination 180, and to determine and generate a delivery route 120 for the UTV 110. In one aspect, the delivery route 120 determined by the central computing device 150 is based on a starting location of the UTV 110 (e.g., a UTV deployment station 185) and the delivery destination 180 of the UTV 110 where the UTV may drop off products 190 or pick up return products 190. In some aspects, the central computing device 150 is configured to calculate multiple possible delivery routes 120 for the UTV 110, and then select a delivery route 120 determined by the central computing device 150 to provide an optimal delivery time and/or conditions while traveling (in-air or on-ground) along the original delivery route 120. In some embodiments, after the control circuit 210 of the central computing device 150 determines and generates a delivery route 120 for the UTV 110, the central computing device 150 transmits, via the output 240 and over the network 115, a signal including the delivery route 120 to the UTV 110 assigned to deliver one or more products 190 from the UTV deployment station 185 to the delivery destination 180.

In some embodiments, the central computing device 150 is capable of integrating 2D and 3D maps of the navigable space of the UTV 110 along the delivery route 120 determined by the central computing device 150, complete with topography data comprising: no fly zones and/or physical obstructions along the delivery route 120, as well as on-ground buildings, hills, bodies of water, power lines, roads, vehicles, people, and/or known safe landing points for the UTV 110 along the delivery route 120. After the central computing device 150 maps all in-air and on-ground objects along the delivery route 120 of the UTV 110 to specific locations using algorithms, measurements, and GPS geo-location, for example, grids may be applied sectioning off the maps into access ways and blocked sections, enabling the UTV 110 to use such grids for navigation and recognition. The grids may be applied to 2D horizontal maps along with 3D models. Such grids may start at a higher unit level and then can be broken down into smaller units of measure by the central computing device 150 when needed to provide more accuracy.

In some embodiments, the central computing device 150 is configured to determine that the delivery route 120 from the UTV deployment station 185 to the delivery destination 180 or vice versa will cause the UTV 110 to travel outside of the network communication range 175 and, based on such a determination, to transmit a signal to the UTV 110 indicating that the UTV 110 is to transmit signals to an IUCV 125 identified in the signal when the UTV 110 is traveling along a portion of the delivery route 120 located outside of the network communication range 175. In one aspect, the central computing device 150 is configured to transmit an alert signal to the UTV 110 over the network 115 indicating that the UTV 110 is about to exit the network communication range 175. In some embodiments, the central computing device 150 is configured to determine that the delivery route 120 will cause the UTV 110 to travel outside of the network communication range 175 and, based on such a determination, transmit a signal to the IUCV 125 identifying the UTV 110 that is going to be traveling outside of the network communication range 175 and indicating that the IUCV 125 is to monitor and/or transmit control signals to the identified UTV 110 when the UTV 110 is traveling along a portion of the delivery route 120 located outside of the network communication range 175.

In some aspects, while the UTV 110 is traveling from the UTV deployment station 185 toward the delivery destination 180 along the delivery route 120, the central computing device 150 is configured to continuously or at regular intervals (e.g., 30 seconds, 1 minute, 5 minutes, 15 minutes, etc.) receive from the UTV 110 one or more sensor inputs such as current physical location of the UTV 110 and/or products 190 being transported by the UTV 110 and/or predicted flight range of the UTV 110 until all battery power is depleted. Such sensor inputs may be received by the central computing device 150 directly or indirectly (e.g., via the central electronic database 160) from the UTV 110 over the network 115, and directly from the UTV 110 (when the UTV 110 is located within the network communication range 175) or indirectly via the IUCV 125 (when the UTV 110 is located outside of the network communication range 175).

In certain aspects, the central electronic database 160 stores electronic data indicating each of the IUCVs 125 available to communicate with and/or control a given UTV 110 traveling along a delivery route 120 that will take the UTV 110 outside of the network communication range 175. In one aspect, the central computing device 150 obtains such data from the central electronic database 160 over the network 115 and analyzes the data obtained from the central electronic database 160 to select, from the IUCVs 125 listed in the central electronic database 160, an IUCV 125 for communicating with (e.g., to relay signals, control, monitor, and/or recharge) the UTV 110 when the UTV 110 is located outside of the network communication range 175. In some embodiments, the central computing device 150 is configured to guide the UTV 110 and the IUCV 125 toward each other, for example, in an event, where the IUCV 125 is to recharge the UTV 110. To that end, in some aspects, the central computing device 150 is configured to determine GPS coordinates of the UTV 110 and the IUCV 125, and to generate a guiding signal that facilitates the travel of the UTV 110 toward the IUCV 125 and vice versa.

FIG. 3 presents a more detailed exemplary embodiment of the UTV 110 of FIG. 1. In this example, the UTV 310 has a housing 302 that contains (partially or fully) or at least supports and carries a number of components. These components include a control unit 304 comprising a control circuit 306 that controls the general operations of the UTV 310. The control unit 304 includes a memory 308 coupled to the control circuit 306 for storing data such as operating instructions and/or useful data.

In some embodiments, the control circuit 306 operably couples to a motorized leg system 309. This motorized leg system 309 functions as a locomotion system to permit the UTV 310 to land onto the ground or onto a landing pad at the delivery destination 180 and/or to move on the ground toward the delivery destination 180 from a UTV deployment station 185 and vice versa. Various examples of motorized leg systems are known in the art. Further elaboration in these regards is not provided here for the sake of brevity save to note that the control circuit 306 may be configured to control the various operating states of the motorized leg system 309 to thereby control when and how the motorized leg system 309 operates.

In the embodiment of FIG. 3, the control circuit 306 operably couples to at least one wireless transceiver 312 that is configured as a two-way transceiver and operates according to any known wireless protocol. This wireless transceiver 312 can comprise, for example, a cellular-compatible, Wi-Fi-compatible, and/or Bluetooth-compatible transceiver that can wirelessly communicate with the central computing device 150 via the network 115 and/or with the IUCV 125 via the communication channel 155. These teachings will accommodate using any of a wide variety of wireless technologies as desired and/or as may be appropriate in a given application setting. These teachings will also accommodate employing two or more wireless transceivers 312. So configured, the control circuit 306 of the UTV 310 can provide information (e.g., sensor input) to the central computing device 150 and/or IUCV 125 and receive information and/or movement (e.g., routing and rerouting) instructions from the central computing device 150 and/or IUCV 125.

In some embodiments, the wireless transceiver 312 is configured to receive a signal containing instructions including the delivery route 120 and/or instructions for guiding the in-air and/or on-ground movements of the UTV 110 transmitted from the central computing device 150 and/or the IUCV 125, and that can transmit one or more signals (e.g., including sensor input information detected by one or more sensors of the UTV 110) to the central computing device 150 and/or the IUCV 125. For example, the control circuit 306 of the UTV 310 can receive control signals from the central computing device 150 (directly or via the IUCV 125) over the network 115 containing instructions regarding directional movement of the UTV 310 along a specific, central computing device-determined delivery route 120 when, for example, flying from the UTV deployment station 185 to the delivery destination 180 to drop off and/or pick up a product 190 or returning from the delivery destination 180 after dropping off or picking up a product 190 to the UTV deployment station 185 In some aspects, the UTV 310 transmits over the network 115 and via the transceiver 312, an alert signal to the central computing device 150 and/or IUCV 125 indicating that the UTV 110 is about to exit and/or enter the network communication range 175.

In particular, as discussed above, the central computing device 150 can be configured to analyze GPS coordinates of the delivery destination 180 designated by the customer, determine a delivery route 120 for the UTV 110 to the delivery destination 180, and transmit to the wireless transceiver 312 of the UTV 110 a first control signal including the delivery route 120 over the network 115. The UTV 110, after receipt of the first control signal and/or guiding signal from the central computing device 150 over the network 115 via the wireless transceiver 312, is configured to navigate, based on the route instructions in the control signal and/or guiding signal, to the delivery destination 180 and/or to the IUCV 125 and/or to the UTV deployment station 185.

With reference to FIG. 3, the control circuit 306 of the UTV 310 also couples to one or more on-board sensors 314 of the UTV 310. These teachings will accommodate a wide variety of sensor technologies and form factors. In some embodiments, the on-board sensors 314 can comprise any relevant device that detects and/or transmits at least one status of the UTV 310 during travel of the UTV 110 along the delivery route 120. The sensors 314 of the UTV 310 can include but are not limited to: altimeter, velocimeter, thermometer, GPS data, photocell, battery life sensor, video camera, radar, lidar, laser range finder, sonar, electronics status, and communication status. In some embodiments, the information obtained by the sensors 314 of the UTV 310 is used by the UTV 310 and/or the central computing device 150 and/or the IUCV 125 in functions including but not limited to: navigation, landing, on-the-ground object detection, potential in-air object detection, distance measurements, topography mapping.

In some aspects, the status input detected and/or transmitted by one or more sensors 314 of the UTV 310 includes but is not limited to GPS coordinates of the UTV 310, marker beacon data along the delivery route 120, and way point data along the delivery route 120. Such data, when obtained by the central computing device 150 and/or the IUCV 125 (either from the UTV 110 or from the central electronic database 160) enables the control circuit 210 of the central computing device 150 and/or the control circuit of the IUCV 125, based on an analysis of at least such location data, to determine a suitable IUCV 125 for communicating with the UTV 110 when the UTV 110 is located outside of the network communication range 175 while performing its mission along the delivery route 120.

For example, in some aspects, the sensors 314 include one or more devices that can be used to capture data related to one or more in-air objects (e.g., other UTVs 310, helicopters, birds, rocks, etc.) located within a threshold distance relative to the UTV 310. For example, the UTV 310 includes at least one on-board sensor 314 configured to detect at least one obstacle between the UTV 310 and the delivery destination 180 designated by the customer. Based on the detection of one or more obstacles by such a sensor 314, the UTV 310 is configured to avoid the obstacle(s). In some aspects, the UTV 310 may attempt to avoid detected obstacles, and if unable to avoid, to notify the central computing device 150 of such a condition. In some aspects, using on-board sensors 314 (such as distance measurement units, e.g., laser or other optical-based distance measurement sensors), the UTV 310 detects obstacles in its path, and flies around such obstacles or stops until the obstacle is clear.

In some aspects, the UTV 310 includes sensors 314 configured to recognize environmental elements along the delivery route 120 of the UTV 310 toward and/or away from the delivery destination 180. Such sensors 314 can provide information that the control circuit 306 of the UTV 310 and/or the control circuit of the IUCV 125 and/or the control circuit 210 of the central computing device 150 can employ to determine a present location, distance, and/or orientation of the UTV 310 relative to one or more in-air objects and/or objects and surfaces at the delivery destination 180 and/or the UTV deployment station 185. These teachings will accommodate any of a variety of distance measurement units including optical units and sound/ultrasound units. A sensor 314 may comprise an altimeter and/or a laser distance sensor device capable of determining a distance to objects in proximity to the sensor 314.

In some aspects, the UTV 310 includes an on-board sensor 314 (e.g., video camera) configured to detect map reference and/or topography and/or people and/or objects at the delivery destination 180 and/or UTV deployment station 185. In some aspects, the sensor 314 of the UTV 310 is configured to transmit (e.g., via internal circuitry and/or via the transceiver 312) still and/or moving images during in-air and/or on-ground movement of the UTV 310 toward or away from the delivery destination 180 to the control circuit of the IUCV 125 and/or control circuit 210 of the central computing device 150, which allows the control circuit of the IUCV 125 and/or control circuit 210 of the central computing device 150 to control and/or adjust the directional movements of the UTV 310 while traveling in a direction toward or away from the delivery destination 180.

In some embodiments, an audio input 316 (such as a microphone) and/or an audio output 318 (such as a speaker) can also operably couple to the control circuit 306 of the UTV 310. So configured, the control circuit 306 can provide for a variety of audible sounds to enable the UTV 310 to communicate with, for example, the central computing device 150, IUCV 125, other UTVs, or other in-air or ground-based electronic devices. Such sounds can include any of a variety of tones and/or sirens and/or other non-verbal sounds. Such audible sounds can also include, in lieu of the foregoing or in combination therewith, pre-recorded or synthesized speech.

In the embodiment shown in FIG. 3, the UTV 310 includes a power source 320 such as one or more batteries. The power provided by the power source 320 can be made available to whichever components of the UTV 310 require electrical energy. By one approach, the UTV 310 includes a plug or other electrically conductive interface that the control circuit 306 can utilize to permit the UTV 310 to physically connect (e.g., via compatible plugs/adapter, magnetic cables, etc.) and/or remotely couple (via induction signals, etc.) to an external source of energy (e.g., IUCV 125, charging station, etc.) in order to recharge and/or replace the power source 320. In some embodiments, the power source 320 is configured as a rechargeable battery that can be recharged by the IUCV 125. In some aspects, the power source 320 is configured to be rechargable by induction (e.g., RF induction, light induction, laser induction, thermal induction, etc.).

These teachings will also accommodate optionally selectively and temporarily coupling the UTV 310 to another structure or electronic device (e.g., IUCV 125, landing pad, deployment dock, etc.). In such aspects, the UTV 310 includes a coupling structure 322. By one approach such a coupling structure 322 operably couples to a control circuit 306 to thereby permit the latter to control movement of the UTV 310 (e.g., via hovering and/or via the motorized leg system 309) towards a particular IUCV 125 (or another charging source) until the coupling structure 322 can engage the IUCV 125 to thereby temporarily physically couple the UTV 310 to the IUCV 125 and enable the IUCV 125 to recharge the UTV 310.

The exemplary UTV 310 of FIG. 3 also includes a an input/output (I/O) device 330 that is coupled to the control circuit 306. The I/O device 330 allows an external device to couple to the control unit 304. The function and purpose of connecting devices will depend on the application. In some examples, devices connecting to the I/O device 330 may add functionality to the control unit 304, allow the exporting of data from the control unit 304, allow the diagnosing of the UTV 310, and so on.

The exemplary UTV 310 of FIG. 3 also includes a user interface 324 including for example, user inputs and/or user outputs or displays depending on the intended interaction with a user (e.g., a worker of a retailer, UTV delivery service, a customer, etc.). For example, user inputs could include any input device such as buttons, knobs, switches, touch sensitive surfaces or display screens, and so on. Example user outputs include lights, display screens, and so on. The user interface 324 may work together with or separate from any user interface implemented at an optional user interface unit (such as a smart phone or tablet device) usable by the worker.

In some embodiments, the UTV 310 may be controlled by a user in direct proximity to the UTV 310, for example, an operator of the UTV deployment station 185 (e.g., a driver of a moving vehicle), or by a user at any location remote to the location of the UTV 310 (e.g., regional or central hub operator). This is due to the architecture of some embodiments where the central computing device 150 and/or IUCV 125 outputs control signals to the UTV 310. These controls signals can originate at any electronic device in communication with the central computing device 150, for example, at the IUCV 125. For example, the signals sent to the UTV 310 may be movement instructions determined by the central computing device 150 and/or initially transmitted by a device of a user to the central computing device 150 and in turn transmitted from the central computing device 150 to the UTV 310.

The control unit 304 of the UTV 310 includes a memory 308 coupled to a control circuit 306 and storing data such as operating instructions and/or other data. The control circuit 306 can comprise a fixed-purpose hard-wired platform or can comprise a partially or wholly programmable platform. These architectural options are well known and understood in the art and require no further description. This control circuit 306 is configured (e.g., by using corresponding programming stored in the memory 308 as will be well understood by those skilled in the art) to carry out one or more of the steps, actions, and/or functions described herein. The memory 308 may be integral to the control circuit 306 or can be physically discrete (in whole or in part) from the control circuit 306 as desired. This memory 308 can also be local with respect to the control circuit 306 (where, for example, both share a common circuit board, chassis, power supply, and/or housing) or can be partially or wholly remote with respect to the control circuit 306. This memory 308 can serve, for example, to non-transitorily store the computer instructions that, when executed by the control circuit 306, cause the control circuit 306 to behave as described herein. It is noted that not all components illustrated in FIG. 3 are included in all embodiments of the UTV 310. That is, some components may be optional depending on the implementation.

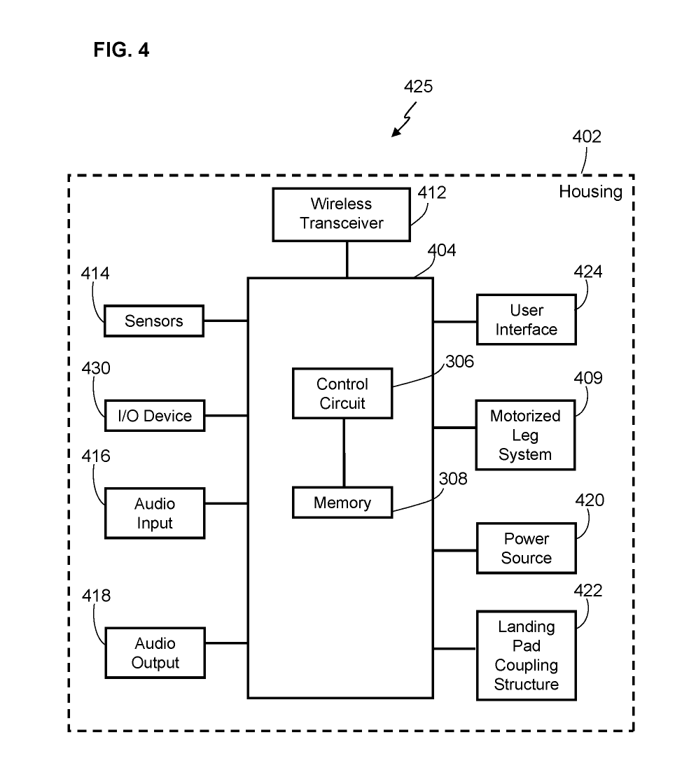

FIG. 4 presents a more detailed exemplary embodiment of the IUCV 125 of FIG. 1. In this example, the IUCV 425 has a housing 402 that contains (partially or fully) or at least supports and carries a number of components. These components include a control unit 404 comprising a control circuit 406 that controls the general operations of the IUCV 425. The control unit 404 includes a memory 408 coupled to the control circuit 406 for storing data such as operating instructions and/or useful data. It will be appreciated that the IUCV 425 may be an unmanned control aerial vehicle, an unmanned control ground vehicle, a manned control aerial vehicle, a manned control ground vehicle, or combinations thereof.

In some embodiments, the control circuit 406 operably couples to a motorized leg system 409. This motorized leg system 409 functions as a locomotion system to permit the IUCV 425 to move on the ground. Further elaboration in these regards is not provided here for the sake of brevity save to note that the control circuit 406 may be configured to control the various operating states of the motorized leg system 409 to thereby control when and how the motorized leg system 409 operates.

In the embodiment of FIG. 4, the control circuit 406 operably couples to at least one wireless transceiver 412 that is configured as a two-way transceiver and operates according to any known wireless protocol. This wireless transceiver 412 can comprise, for example, a cellular-compatible, Wi-Fi-compatible, and/or Bluetooth-compatible transceiver that can wirelessly communicate with the central computing device 150 via the network 115 and communication channel 145 and with the UTV 110 over the communication channel 155. These teachings will accommodate using any of a wide variety of wireless technologies as desired and/or as may be appropriate in a given application setting. These teachings will also accommodate employing two or more wireless transceivers 412. In some embodiments, the wireless transceiver 412 of the IUCV 425 facilitates communication between the central computing device 150 and the UTV 110 that is located outside of the communication range 175 of the central computing device 150.

In some embodiments, the control circuit 406 of the IUCV 425 can provide information (e.g., movement instructions) to the UTV 110 and can receive information (e.g., sensor input) from the UTV 110 via the wireless transceiver 412. In some aspects, the control circuit 406 of the IUCV 425 can provide information (e.g., routing/rerouting decisions pertaining to the UTV 110) to the central computing device 150 via the wireless transceiver 412 (and over the communication channel 145) and can receive information (e.g., control signals) from the central computing device 150 via the wireless transceiver 412 (and over the communication channel 145).

In certain embodiments, the IUCV 425 is configured such that the control circuit 406 receives, from the central computing device 150 and via the wireless transceiver 412 over the network 115 and communication channel 145, a control signal including data indicating a delivery route 120 that guides the UTV 110 located outside of the network communication range 175 to the delivery destination 180. After the IUCV 425 receives such a control signal, the control circuit 406 of the IUCV 425 is programmed to transmit (i.e., relay) this control signal via the communication channel 155 to the UTV 110 located outside of the network communication range 175 of the central computing device 150 to guide such a UTV 110 along the delivery route 120 to the delivery destination 180.

In some embodiments, the control circuit 406 of the IUCV 125 is configured to analyze the status data received from the UTV 110 and/or the delivery route data received from the central computing device 150 and to alter the delivery route 120 of the UTV 110 based on one or more of the status data received from the UTV 110 and the delivery route data received from the central computing device 150. For example, in some aspects, based on the status data (e.g., GPS data) received from the UTV 110, the control circuit 406 of the IUCV 425 is configured to track GPS coordinates of the UTV 110 located outside of the network communication range 175. In one aspect, the control circuit 406 is programmed, in response to a determination that the tracked GPS coordinates indicate that the UTV 110 located outside of the network communication range 175 is off the delivery route 120 that was previously transmitted to the UTV 110 (e.g., by the central computing device 150), to transmit, via the wireless transceiver 412 and over the communication channel 155, a rerouting signal to the UTV 110 located outside of the network communication range 175 in order to reroute the UTV 110 onto the delivery route 120 to the delivery destination 180.

In some implementations, the IUCV 425 is configured to authenticate electronic devices attempting to communicate with the IUCV 425 or with the UTV 110 located outside of the network communication range 175. In some aspects, the control circuit 406 of the IUCV 425 is programmed to permit an electronic device to communicate with the IUCV 425 only after the electronic device transmits an authenticated electronic access key to the IUCV 425. Such an authenticated electronic access key may be obtained by an authorized electronic device (e.g., UTV 110, central computing device 150, etc.) from the central electronic database 160 in some embodiments. In one aspect, the control circuit 406 of the IUCV 425 is programmed to permit an electronic device to communicate with the UTV 110 located outside of the network communication range 175 only after such an electronic device transmits an authenticated electronic access key to the IUCV 425.

With reference to FIG. 4, the control circuit 406 of the IUCV 425 also couples to one or more on-board sensors 414 of the IUCV 425. These teachings will accommodate a wide variety of sensor technologies and form factors. In some embodiments, the on-board sensors 414 can comprise any relevant device that detects and/or transmits at least one status of the IUCV 425 during (in-air or on ground) movement of the IUCV 425. The sensors 414 of the IUCV 425 can include but are not limited to: altimeter, velocimeter, thermometer, weather (e.g., air temperature, wind, rain, snow, etc.) sensor, GPS data, photocell, battery life sensor, video camera, radar, lidar, laser range finder, sonar, electronics status, and communication status. In some embodiments, the information obtained by the sensors 414 of the IUCV 425 is used by the control circuit 406 of the IUCV 425 in functions including but not limited to: navigation, landing, on-the-ground object detection, potential in-air object detection, distance measurements, topography mapping.

In some aspects, the status input detected and/or transmitted by one or more sensors 414 of the IUCV 425 includes but is not limited to GPS coordinates of the IUCV 425, marker beacon data, and way point data. Such data, when obtained by the control circuit 406 of the IUCV 425 or by central computing device 150 (e.g., from the IUCV 425 or the central electronic database 160) enables the control circuit 210 of the central computing device 150 and/or the control circuit 406 of the IUCV 425, based on an analysis of at least location data, to determine a UTV 110 outside of the network communication range 175 which the IUCV 425 is to communicate with.

In some aspects, the sensors 414 include one or more devices that can be used to capture data related to one or more in-air or on-ground objects (e.g., UTVs 110, other IUCVs 425, helicopters, cars, bicycles, pedestrians, birds, rocks, etc.) located within a threshold distance relative to the IUCV 425. For example, in some embodiments, the IUCV 425 includes at least one on-board sensor 414 configured to detect at least one obstacle between the IUCV 425 and intended destination of the IUCV 425. Based on the detection of one or more obstacles by such a sensor 414, the IUCV 425 is configured to avoid the obstacle(s). In some aspects, the IUCV 425 may attempt to avoid detected obstacles, and if unable to avoid, to notify the central computing device 150 of such a condition. In some aspects, using on-board sensors 414 (such as distance measurement units, e.g., laser or other optical-based distance measurement sensors), the IUCV 425 detects obstacles in its path, and flies around such obstacles or stops until the obstacle is clear.

In some aspects, the IUCV 425 includes sensors 414 configured to detect disruptive electronic devices configured to disrupt operation of the UTV 110 located outside of the network communication range 175 (and/or the UTV 110 located within the network communication range 175). Exemplary disruptive electronic devices that may be detected by one or more sensors 414 of the IUCV 425 include but are not limited to rogue unmanned aerial vehicles, rogue unmanned ground vehicles, unmanned aerial and/or ground vehicle shields, and jamming devices.

In some aspects, the IUCV 425 includes sensors 414 configured to recognize environmental elements during movement of the IUCV 425. Such sensors 414 can provide information that the control circuit 406 of the IUCV 425 and/or the central computing device 150 can employ to determine a present location, distance, and/or orientation of the IUCV 425 relative to one or more in-air objects and/or on-ground objects and surfaces. These teachings will accommodate any of a variety of distance measurement units including optical units and sound/ultrasound units. A sensor 414 may comprise an altimeter and/or a laser distance sensor device capable of determining a distance to objects in proximity to the sensor 414.

In some aspects, the IUCV 425 includes an on-board 414 (e.g., a video camera) configured to detect map reference and/or topography and/or people and/or objects during movement of the IUCV 425. In some aspects, the sensor 414 of the IUCV 425 is configured to transmit (e.g., via internal circuitry and/or via the transceiver 412) still and/or moving images during the in-air or on-ground movement of the IUCV 425 to the control circuit 406 of the IUCV 425 and/or the control circuit 210 of the central computing device 150, which allows the control circuit 406 of the IUCV 425 and/or the control circuit 210 of the central computing device 150 to control and/or adjust the directional movements of the IUCV 425.

In some aspects, an audio input sensor 416 (such as a microphone) and/or an audio output 418 (such as a speaker) can also operably couple to the control circuit 406 of the IUCV 425. So configured, the control circuit 406 can provide for a variety of audible sounds to enable the IUCV 425 to communicate with, for example, the central computing device 150, UTV 110, other IUCVs 425, or other in-air or ground-based electronic devices. Such sounds can include any of a variety of tones and/or sirens and/or other non-verbal sounds. Such audible sounds can also include, in lieu of the foregoing or in combination therewith, pre-recorded or synthesized speech.

The IUCV 425 depicted in FIG. 4 includes a power source 420 such as one or more batteries. The power provided by the power source 420 can be made available to whichever components of the IUCV 425 require electrical energy. By one approach, the IUCV 425 includes a plug or other electrically conductive interface that the control circuit 406 can utilize to permit the IUCV 425 to physically connect (e.g., via compatible plugs/adapter, magnetic cables, etc.) and/or remotely couple (via induction signals, etc.) to an external source of energy (e.g., charging dock) in order to recharge and/or replace the power source 420. For example, in some embodiments, the power source 420 is configured as a rechargeable battery that can be recharged at a docking station. In some aspects, the power source 420 may be configured as a device that can be recharged by induction (e.g., RF induction, light induction, laser induction, thermal induction, etc.). In some aspects, the IUCV 425 may be gas-powered (e.g., blimp, etc.).

In some embodiments, the power source 420 of the IUCV 425 is coupled to a sensor 414 configured to monitor battery power level of the IUCV 425. In some aspects, the IUCV 425 is configured to recharge a battery of the UTV 310 by transferring at least some power from the power source 420 to the battery 320 of the UTV 310 that is in need of a battery recharge. In one aspect, the IUCV 425 is configured to recharge a battery 320 of a UTV 310 located outside of the network communication range 175 and in need of a battery recharge by deploying inductive power (e.g., RF induction, light induction, laser induction, thermal induction, etc.) to power the battery 320 of the UTV 310. In some embodiments, the IUCV 425 is configured such that the power source 420 is a solar power generator device configured to receive power from solar energy.

The exemplary IUCV 425 of FIG. 4 also includes an input/output (I/O) device 430 that is coupled to the control circuit 406. The I/O device 430 allows an external device to couple to the control unit 404. The function and purpose of connecting devices will depend on the application. In some examples, devices connecting to the I/O device 430 may add functionality to the control unit 404, allow the exporting of data from the control unit 404, allow the diagnosing of the IUCV 425, and so on.

The exemplary IUCV 425 of FIG. 4 also includes a user interface 424 including for example, user inputs and/or user outputs or displays depending on the intended interaction with a user (e.g., a worker of a retailer, UTV delivery service, a customer, etc.). For example, user inputs could include any input device such as buttons, knobs, switches, touch sensitive surfaces or display screens, and so on. Example user outputs include lights, display screens, and so on. The user interface 424 may work together with or separate from any user interface implemented at an optional user interface unit (such as a smart phone or tablet device) usable by the worker.

In some embodiments, the IUCV 425 may be controlled by a user in direct proximity to the IUCV 425, for example, an operator of the UTV deployment station 185 (e.g., a driver of a moving vehicle), or by a user at any location remote to the location of the IUCV 425 (e.g., regional or central hub operator). This is due to the architecture of some embodiments where the central computing device 150 outputs control signals to the IUCV 425. These controls signals can originate at any electronic device in communication with the central computing device 150.

The control unit 404 of the IUCV 425 includes a memory 408 coupled to a control circuit 406 and storing data such as operating instructions and/or other data. The control circuit 406 can comprise a fixed-purpose hard-wired platform or can comprise a partially or wholly programmable platform. These architectural options are well known and understood in the art and require no further description. This control circuit 406 is configured (e.g., by using corresponding programming stored in the memory 408 as will be well understood by those skilled in the art) to carry out one or more of the steps, actions, and/or functions described herein. The memory 408 may be integral to the control circuit 406 or can be physically discrete (in whole or in part) from the control circuit 406 as desired. This memory 408 can also be local with respect to the control circuit 406 (where, for example, both share a common circuit board, chassis, power supply, and/or housing) or can be partially or wholly remote with respect to the control circuit 406. This memory 408 can serve, for example, to non-transitorily store the computer instructions that, when executed by the control circuit 406, cause the control circuit 406 to behave as described herein. It is noted that not all components illustrated in FIG. 4 are included in all embodiments of the IUCV 425. That is, some components may be optional depending on the implementation.

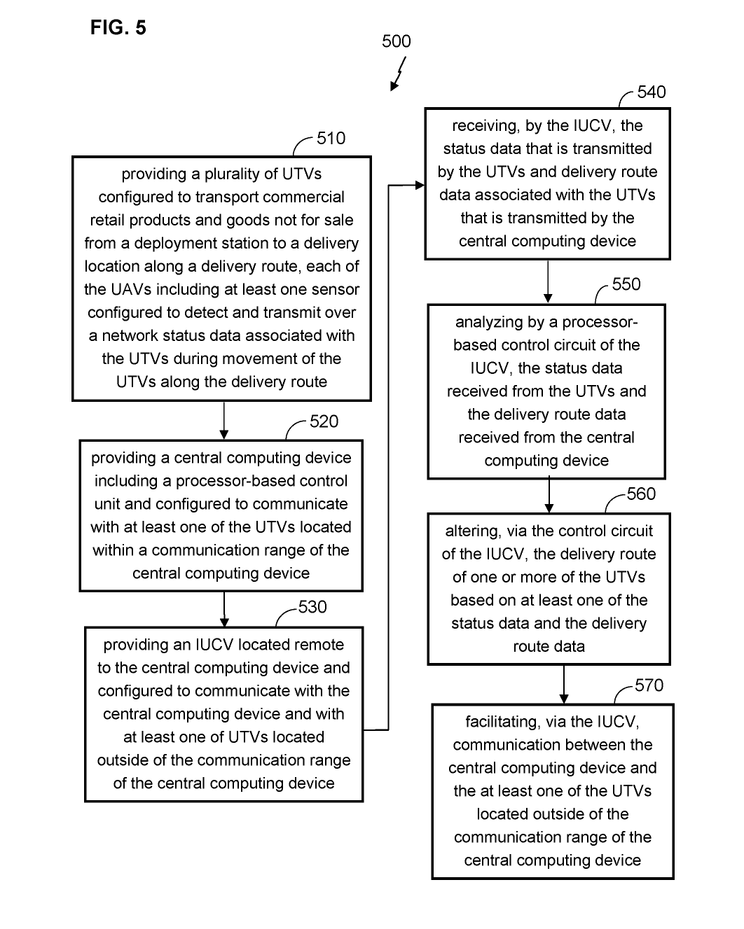

FIG. 5 shows an embodiment of an exemplary method 500 of controlling a plurality of UTVs 110. For exemplary purposes, the method 500 is described in the context of the system 100 of FIG. 1, but it is understood that embodiments of the method 500 may be implemented in this or other systems. The embodiment of the method 500 illustrated in FIG. 5 includes providing a plurality of UTVs 110 configured to transport commercial retail products 190 as well as goods not for sale from a UTV deployment station 185 to a delivery destination 180 along a delivery route 120, with each of the UTVs 110 including at least one sensor configured to detect and transmit over a network 115 status data associated with the UTVs 110 during movement of the UTVs 110 along the delivery route 120 (step 510).

The method 500 further includes providing a central computing device 150 including a processor-based control unit 210 and configured to communicate with at least one of the UTVs 110 located within a network communication range 175 of the central computing device 150 (step 520). In addition, the exemplary method 500 includes providing an IUCV 125 located remote to the central computing device 150 and configured to communicate with the central computing device 150 and with one or more UTVs 110 located outside the network communication range 175 of the central computing device 150 (step 530).

As discussed above, the central computing device 150 is configured to obtain and analyze the relative locations of the UTV deployment station 185 and delivery destination 180 in order to determine a delivery route 120 for the UTV 110 from the UTV deployment station 185 to the delivery destination 180. For example, in some embodiments, the central computing device 150 obtains GPS data associated with the delivery destination 180 from the customer information database 140 and GPS data associated with the UTV deployment station 185 from the central electronic database 160. As discussed above, the customer information database 140 and the central electronic database 160 may be implemented as a single database.

In some aspects, when the UTV 310 is traveling (in-air or on the ground) along the delivery route 120 from the UTV deployment station 185 to the delivery destination 180, the onboard sensors 314 of the UTV 310 monitor various parameters relating to the delivery mission of the UTV 310 and the status of the UTV 310. The sensor inputs detected by the onboard sensors 314 of the UTV 310 are transmitted (e.g., via the wireless transceiver 312) to the central computing device 150 (when the UTV 310 is within the network communication range 175) and/or to the IUCV 425 (when the UTV 310 is outside of the network communication range 175) and/or to the central electronic database 160 over the network 115. To that end, the method 500 includes receiving, by the IUCV 125, the status data that is transmitted by the UTVs 110 and delivery route data associated with the UTVs 110 that is transmitted by the central computing device 150 (step 540). Such status data and delivery route data transmitted by the UTVs 110 to the IUCV 125 is analyzed by the control circuit 406 of the IUCV 425 in order to make decisions regarding whether the UTV 110 is to be rerouted. To that end, the method 500 of FIG. 5 includes analyzing by a processor-based control circuit 406 of the IUCV 425, the status data received from the UTVs 110 and the delivery route data received from the central computing device 150 (step 550).

While the data detected by the sensors 314 is expected to, in most cases, indicate that the delivery mission of the UTV 110 is going as planned along the predetermined delivery route 120, in certain situations, the data detected by the sensors 314 of the UTV 310 may indicate that the UTV 310 that is located outside of the communication range 175 of the central computing device 150 over the network 115 has deviated from the delivery route 120, or must be rerouted (e.g., due to an unforeseen no-fly zone) from its predetermined delivery route 120. To that end, in the embodiment illustrated in FIG. 5, the method 500 includes altering, via the control circuit 406 of the IUCV 425, the delivery route 120 of one or more of the UTVs 110 based on at least one of the status data and the delivery route data (step 560). For example, in some aspects, based on an analysis of one or more status inputs received from the UTV 310, the control circuit 406 of the IUCV 425 may determine that the UTV 310 does not have sufficient battery power to complete its delivery mission, and may generate and transmit a control signal (over the communication channel 155) to the UTV 310 configured to guide the UTV 310 to a location, where the UTV 310 can be recharged (e.g., by the IUCV 425 or by another charging device). In some aspects, after the control circuit 406 of the IUCV 425 determines that the UTV 310 is to be rerouted for any reason, the control circuit 406 is programmed to transmit an alert signal indicative of such rerouting to the central electronic database 160 and/or the central computing device 150 over the network 115.

As discussed above, the IUCV 425 in effect extends the communication capability of the central computing device 150 beyond its network communication range 175, and provides for the monitoring and control of the UTVs 110 even when the UTVs 110 are located outside of the network communication range 175. As such, the method 500 includes facilitating, via the IUCV 425, communication between the central computing device 150 and the UTV 110 located outside of the communication range 175 of the central computing device 150 (step 570).

The systems and methods described herein advantageously provide for controlling unmanned transport vehicles even when such vehicles are located outside of the communication range of the central computing device. As such, the systems and methods described herein not only advantageously enable the unmanned transport vehicle to complete their missions without losing communication with the central station, but also advantageously provide for routing and rerouting of UTVs even when they are not within the communication range of the central station.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for controlling a plurality of unmanned transport vehicles, the system comprising:
a plurality of unmanned transport vehicles configured to transport commercial retail products and goods not for sale from a deployment station to a delivery destination along a delivery route, each of the unmanned transport vehicles including at least one sensor configured to detect and transmit over a network status data associated with the unmanned transport vehicles during movement of the unmanned transport vehicles along the delivery route;
a central computing device including a processor-based control unit and configured to communicate with at least one of the unmanned transport vehicles located within a communication range of the central computing device; and
an intermediate unmanned control vehicle located remote to the central computing device and configured to communicate with the central computing device and with at least one of the unmanned transport vehicles located outside of the communication range of the central computing device;
wherein the intermediate unmanned control vehicle is configured to receive the status data that is transmitted by the unmanned transport vehicles and delivery route data associated with the unmanned transport vehicles that is transmitted by the central computing device;
wherein the intermediate unmanned control vehicle includes a processor-based control circuit configured to analyze the status data received from the unmanned transport vehicles and the delivery route data received from the central computing device and to alter the delivery route of one or more of the unmanned transport vehicles based on at least one of the status data and the delivery route data; and
wherein the intermediate unmanned control vehicle facilitates communication between the central computing device and the at least one of the unmanned transport vehicles located outside of the communication range of the central computing device.

2. The system of claim 1, wherein the intermediate unmanned control vehicle comprises at least one of an intermediate unmanned control aerial vehicle, an intermediate unmanned control ground vehicle, and wherein the plurality of unmanned transport vehicles comprises at least one of an unmanned aerial vehicle and unmanned ground vehicle.

3. The system of claim 1, wherein the intermediate unmanned control vehicle is configured to receive at least one of a digital photograph and a digital video over the network from the at least one of the unmanned transport vehicles located outside of the communication range of the central computing device, and to transmit the received digital photograph or digital video to the central computing device.

4. The system of claim 1, wherein the intermediate unmanned control vehicle is configured to monitor battery power level of the at least one of the unmanned transport vehicles located outside of the communication range of the central computing device, and to deploy inductive power in order to recharge a battery of the at least one of the unmanned transport vehicles located outside of the communication range of the central computing device and being in need of a battery recharge.

5. The system of claim 1, wherein the intermediate unmanned control vehicle is configured to:
receive delivery route data including a control signal from the central computing device, the control signal including instructions to guide the at least one of the unmanned transport vehicles located outside of the communication range of the central computing device along the delivery route to the delivery destination; and
transmit the control signal to the at least one of the unmanned transport vehicles located outside of the communication range of the central computing device in order to guide the at least one of the unmanned transport vehicles located outside of the communication range of the central computing device along the delivery route to the delivery destination.

6. The system of claim 5, wherein the intermediate unmanned control vehicle is configured to:
track global positioning system (GPS) coordinates of the at least one of the unmanned transport vehicles located outside of the communication range of the central computing device;
determine that the tracked GPS coordinates indicate that the at least one of the unmanned transport vehicles located outside of the communication range of the central computing device is off the delivery route transmitted to the at least one of the unmanned transport vehicles located outside of the communication range of the central computing device; and
transmit a rerouting signal to the at least one of the unmanned transport vehicles located outside of the communication range of the central computing device in order to reroute the at least one of the unmanned transport vehicles located outside of the communication range of the central computing device onto the delivery route to the delivery destination.

7. The system of claim 1, wherein the intermediate unmanned control vehicle includes at least one sensor configured to detect disruptive electronic devices configured to disrupt operation of the at least one of the unmanned transport vehicles located outside of the communication range of the central computing device, the disruptive electronic devices comprising: rogue unmanned aerial vehicles, rogue unmanned ground vehicles, unmanned aerial vehicle shields, unmanned ground vehicle shields, and jamming devices.

8. The system of claim 1, wherein the intermediate unmanned control vehicle is configured to authenticate electronic devices attempting to communicate with the intermediate unmanned control vehicle or with the unmanned transport vehicles located outside of the communication range of the central computing device.

9. The system of claim 8, wherein the intermediate unmanned control vehicle is configured to:
permit an electronic device to communicate with the intermediate unmanned control vehicle only after the electronic device transmits an authenticated electronic access key to the intermediate unmanned control vehicle; and
permit an electronic device to communicate with the unmanned transport vehicles located outside of the communication range of the central computing device only after the electronic device transmits an authenticated electronic access key to the intermediate unmanned control vehicle.

10. The system of claim 1, wherein the intermediate unmanned control vehicle includes a solar power generator device configured to receive power from solar energy.

11. A method for controlling a plurality of unmanned transport vehicles, the method comprising:
providing a plurality of unmanned transport vehicles configured to transport commercial retail products and goods not for sale from a deployment station to a delivery destination along a delivery route, each of the unmanned transport vehicles including at least one sensor configured to detect and transmit over a network status data associated with the unmanned transport vehicles during movement of the unmanned transport vehicles along the delivery route;
providing a central computing device including a processor-based control unit and configured to communicate with at least one of the unmanned transport vehicles located within a communication range of the central computing device;
providing an intermediate unmanned control vehicle located remote to the central computing device and configured to communicate with the central computing device and with at least one of the unmanned transport vehicles located outside of the communication range of the central computing device;
receiving, by the intermediate unmanned control vehicle, the status data that is transmitted by the unmanned transport vehicles and delivery route data associated with the unmanned transport vehicles that is transmitted by the central computing device;
analyzing by a processor-based control circuit of the intermediate unmanned control vehicle, the status data received from the unmanned transport vehicles and the delivery route data received from the central computing device;
altering, via the control circuit of the intermediate unmanned control vehicle, the delivery route of one or more of the unmanned transport vehicles based on at least one of the status data and the delivery route data; and
facilitating, via the intermediate unmanned control vehicle, communication between the central computing device and the at least one of the unmanned transport vehicles located outside of the communication range of the central computing device.

12. The method of claim 11, wherein the intermediate unmanned control vehicle comprises at least one of an intermediate unmanned control aerial vehicle, an intermediate unmanned control ground vehicle, and wherein the plurality of unmanned transport vehicles comprises at least one of an unmanned aerial vehicle and unmanned ground vehicle.

13. The method of claim 11, further comprising receiving, by the intermediate unmanned control vehicle, at least one of a digital photograph and a digital video over the network from the at least one of the unmanned transport vehicles located outside of the communication range of the central computing device, and transmitting, from the intermediate unmanned control vehicle, the received digital photograph or digital video to the central computing device.

14. The method of claim 11, further comprising monitoring, via the intermediate unmanned control vehicle, battery power level of the at least one of the unmanned transport vehicles located outside of the communication range of the central computing device, and deploying inductive power via the intermediate unmanned control vehicle in order to recharge a battery of the at least one of the unmanned transport vehicles located outside of the communication range of the central computing device and being in need of a battery recharge.

15. The method of claim 11, further comprising:
receiving, by the intermediate unmanned control vehicle, delivery route data including a control signal from the central computing device, the control signal including instructions to guide the at least one of the unmanned transport vehicles located outside of the communication range of the central computing device along the delivery route to the delivery destination; and
transmitting, from the intermediate unmanned control vehicle, the control signal to the at least one of the unmanned transport vehicles located outside of the communication range of the central computing device in order to guide the at least one of the unmanned transport vehicles located outside of the communication range of the central computing device along the delivery route to the delivery destination.

16. The method of claim 15, further comprising:
tracking, via the intermediate unmanned control vehicle, global positioning system (GPS) coordinates of the at least one of the unmanned transport vehicles located outside of the communication range of the central computing device;
determining, via the intermediate unmanned control vehicle, that the tracked GPS coordinates indicate that the at least one of the unmanned transport vehicles located outside of the communication range of the central computing device is off the delivery route transmitted to the at least one of the unmanned transport vehicles located outside of the communication range of the central computing device; and
transmitting, from the intermediate unmanned control vehicle, a rerouting signal to the at least one of the unmanned transport vehicles located outside of the communication range of the central computing device in order to reroute the at least one of the unmanned transport vehicles located outside of the communication range of the central computing device onto the delivery route to the delivery destination.

17. The method of claim 11, further comprising detecting, via at least one sensor of the intermediate unmanned control vehicle, disruptive electronic devices configured to disrupt operation of the at least one of the unmanned transport vehicles located outside of the communication range of the central computing device, the disruptive electronic devices comprising: rogue unmanned aerial vehicles, rogue unmanned ground vehicles, unmanned aerial vehicle shields, unmanned ground vehicle shields, and jamming devices.

18. The method of claim 11, further comprising authenticating, via the intermediate unmanned control vehicle, electronic devices attempting to communicate with the intermediate unmanned control vehicle or with the unmanned transport vehicles located outside of the communication range of the central computing device.

19. The method of claim 18, further comprising:
permitting, by the intermediate unmanned control vehicle, an electronic device to communicate with the intermediate unmanned control vehicle only after the electronic device transmits an authenticated electronic access key to the intermediate unmanned control vehicle; and
permitting, by the intermediate unmanned control vehicle, an electronic device to communicate with the unmanned transport vehicles located outside of the communication range of the central computing device only after the electronic device transmits an authenticated electronic access key to the intermediate unmanned control vehicle.

20. The method of claim 11, wherein the providing the intermediate unmanned control vehicle step further comprises providing the intermediate unmanned control vehicle with a solar power generator device configured to receive power from solar energy.
